(19) United States
(12) Patent Application Publication
(10) Pub. No.: US 2008/0158451 A1
(43) Pub. Date: Jul. 3, 2008

(54) Systems for displaying images

(75) Inventor: Ching-Yu Chang, Su-ao Township (TW)

Correspondence Address: LIU & LIU, 444 S. FLOWER STREET, SUITE 1750, LOS ANGELES, CA, 90071, US

(73) Assignee: TPO Displays Corp.

(21) Appl. No.: 12/004,180

(22) Filed: Dec. 20, 2007

(30) Foreign Application Priority Data
Dec. 29, 2006 (TW) 095149908

(51) Int. Cl. G02F 1/13363; G02F 1/1333

(52) U.S. Cl. 349/33; 349/119

(57) ABSTRACT

Systems for displaying images are provided. A representative system comprises a dual domain electrical compensated birefringence liquid crystal display (ECB-LCD) panel. A pair of uniaxial 1/4λ compensation films is separately disposed on both outer surfaces of the dual domain ECB-LCD panel. A pair of uniaxial 1/2λ compensation films is separately disposed on outer surfaces of the pair of uniaxial 1/4λ compensation films. A pair of polarizers is separately disposed on both outer surfaces of the pair of the uniaxial 1/2λ optical compensation films.

### BACKGROUND OF THE INVENTION

1. Field of the Invention

The invention relates to systems for displaying images, and more particularly to wide viewing angle dual domain electrically controlled birefringence liquid crystal display (ECB-LCD) devices.

2. Description of the Related Art

Liquid crystal display (LCD) devices have many advantages such as small volume, light weight and low power consumption, and due to their increased portability are applicable in a variety of electronic and communication devices including notebook computers, personal digital assistants (PDA), mobile phones and the like. Typically, liquid crystal displays include a color filter substrate, an active matrix substrate and a liquid crystal layer interposed therebetween. Due to the intrinsic optical anisotropy of liquid crystal display materials, incident light from different directions can produce different effective birefringences. Therefore, the viewing angle of conventional LCDs is not as wide as in self-luminescent displays, such as cathode-ray tubes (CRTs), organic light-emitting diodes (OLEDs) and plasma display panels (PDPs).

Conventional LCD device limitations of narrow viewing angle correspondingly limit applications thereof. FIG. 1 is a schematic view of a conventional electrically controlled birefringence liquid crystal display (ECB-LCD) device. As shown, a single domain ECB-LCD device 1 includes a single domain ECB-LCD cell 10 configured with a pair of ¼λ optical compensation films 11, 12 and a pair of ½λ optical compensation films 13, 14 separately disposed on both sides of the ECB-LCD cell 10. A pair of polarizers 15, 16 is separately disposed on the outer surface of the ½λ optical compensation films 13, 14. Since the ECB-LCD cell 10 with single domain is characterized by its optical anisotropism, gray scale inversion occurs along liquid molecule tilt direction resulting in display image distortion and deteriorated chromatic aberration from all viewing directions.

FIG. 2 is a schematic view of a conventional single domain ECB-LCD cell structure. An ECB-LCD cell 10 includes an upper substrate 7, lower substrate 3, and a liquid crystal layer 5 interposed therebetween. The liquid crystal layer 5 is oriented along rubbing direction R. The upper substrate 7 is typically referred as a color filter substrate with a continuous common electrode 6 thereon. The lower substrate 3 is typically referred as an active matrix substrate with a continuous pixel electrode 4 thereon. A single domain is formed between the continuous common electrode 6 and the continuous pixel electrode 4. Orientation of the liquid crystal molecules is asymmetric such that phase difference occurs from different observation angles (V₁ and V₂). The image of the single domain ECB-LCD cell 10 is prone to chromatic deviation and gray scale inversion from different observation angles (V₁ and V₂), deteriorating image quality of the ECB-LCD device.

Accordingly, it would be beneficial to improve conventional single domain ECB-LCD devices ameliorating chromatic deviation and gray scale inversion due to liquid crystal molecule asymmetry.

### BRIEF SUMMARY OF THE INVENTION

Accordingly, the invention is directed to a system for displaying images with dual domain or multiple domain ECB-LCD devices to ameliorate chromatic deviation and gray scale inversion due to liquid crystal molecule asymmetry.

The invention provides a system for displaying images, comprising a dual domain electrically controlled birefringence liquid crystal display (ECB-LCD) panel having two domains, each domain comprising different liquid crystal orientations. A pair of uniaxial ¼λ compensation films is separately disposed on both sides of the ECB-LCD panel. A pair of uniaxial ½λ compensation films is separately disposed on each of the pair of uniaxial ¼λ compensation films. A pair of polarizers separately is disposed on each of the pair of uniaxial ½λ compensation films.

The invention also provides a system for displaying images, comprising a dual domain electrically controlled birefringence liquid crystal display (ECB-LCD) panel which comprises a first substrate with a patterned first electrode thereon, a second substrate opposing the first substrate with a gap interposed therebetween, wherein a patterned second electrode is disposed on the second substrate, and a liquid crystal layer interposed in the gap between the first and the second substrates. A first uniaxial ¼λ compensation film is disposed on an outer surface of the first substrate. A second uniaxial ¼λ compensation film is disposed on an outer surface of the second substrate. A first uniaxial ½λ compensation film is disposed on an outer surface of the first uniaxial ¼λ compensation film. A second uniaxial ½λ compensation film is disposed on an outer surface of the second uniaxial ¼λ compensation film. A first polarizer is disposed on an outer surface of the first uniaxial ½λ compensation film. A second polarizer is disposed on an outer surface of the second uniaxial ½λ compensation film.

### BRIEF DESCRIPTION OF THE DRAWINGS

The invention can be more fully understood by reading the subsequent detailed description and examples with references made to the accompanying drawings, wherein:

FIG. 1 is a schematic view of a conventional electrically controlled birefringence liquid crystal display (ECB-LCD) device;

FIG. 2 is a schematic view of conventional single domain ECB-LCD cell structure;

FIG. 3 is a schematic view of an exemplary embodiment of a dual domain ECB-LCD device;

FIG. 4 is a schematic view of an embodiment of a dual domain ECB liquid crystal cell;

FIG. 5 is a schematic diagram of a display module comprising the dual domain ECB-LCD panel of the invention; and

FIG. 6 is a schematic diagram of an electronic device, incorporating a display module comprising the dual domain ECB-LCD panel of the invention.

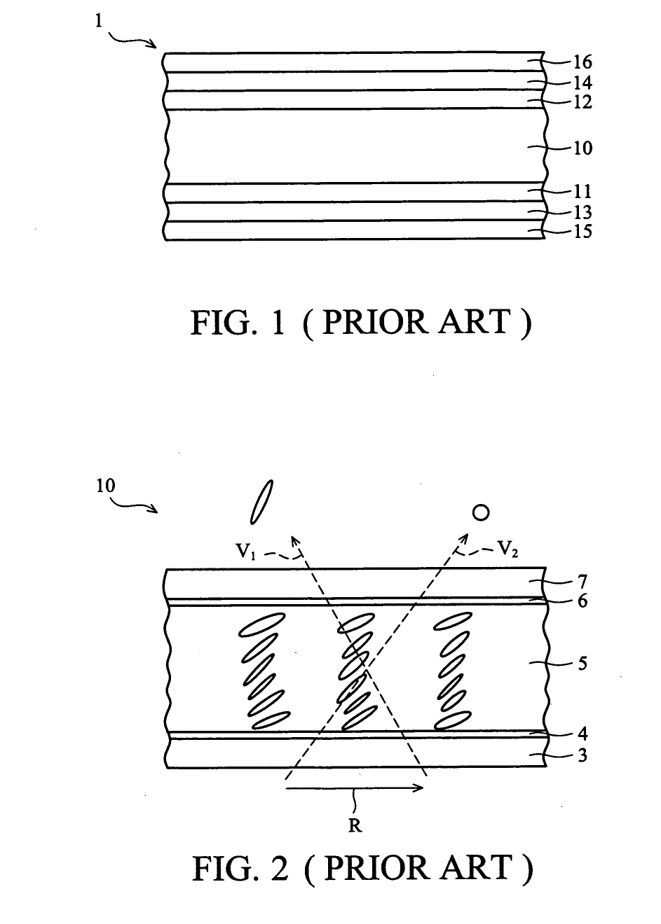

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Before explaining the disclosed invention in detail, it is to be understood that the invention is not limited in its application to the details of the particular arrangements shown since the invention is capable of other embodiments. Also, the terminology used herein is for the purpose of description and not limitation.

Embodiments of the invention provide a system for displaying images, including a normally white mode dual domain ECB-LCD device. The dual domain ECB-LCD device combines with a pair of uniaxial ¼λ compensation films and a pair of uniaxial ½λ compensation films, thus effectively solving optical asymmetry problems and ameliorating chromatic deviation and gray scale inversion. According to an exemplary embodiment, the dual domain ECB-LCD device comprises patterned pixel electrodes and patterned common electrodes creating a symmetrical electric field therebetween. Liquid crystal molecules are thus affected by the symmetrical electric field indicating two domains. Since the two domains are symmetrical, the ECB-LCD device comprises the same phase differences from different observation angles (V₁ and V₂), thereby ameliorating chromatic deviation and gray scale inversion.

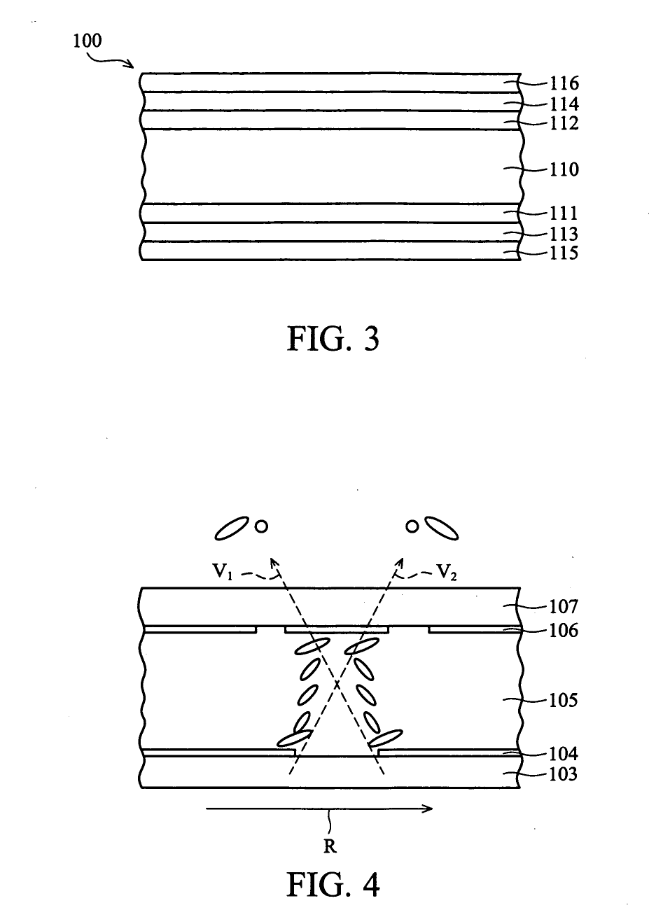

FIG. 3 is a schematic view of an exemplary embodiment of a dual domain ECB-LCD device. In FIG. 3, a dual domain ECB-LCD device 100 comprises a dual domain ECB liquid crystal cell 110 combined with a pair of uniaxial ¼λ compensation films 111, 112 and a pair of uniaxial ½λ compensation films 113, 114 separately disposed on both sides of the dual domain ECB liquid crystal cell 110. A pair of polarizers 115, 116 is separately disposed on an outer surface of the pair of uniaxial ½λ compensation films 113, 114. Since the dual domain ECB liquid crystal cell 110 is optically symmetrical, chromatic deviation and gray scale inversion can thus be ameliorated.

According to an exemplary embodiment, the dual domain ECB liquid crystal cell 110 comprises patterned pixel electrodes and patterned common electrodes creating a symmetrical electric field therebetween. When the patterned pixel electrodes and patterned common electrodes are biased, electrical flux is redistributed due to patterned pixel electrodes and common electrodes. Under this conduction, liquid crystal molecules are redistributed by the symmetrical electric field, thus indicating two domains. Since the two domains are symmetrical, the ECB-LCD device comprises the same phase differences from different observation angles (V₁ and V₂), thereby ameliorating chromatic deviation and gray scale inversion.

FIG. 4 is a schematic view of an embodiment of a dual domain ECB liquid crystal cell. In FIG. 4, a dual domain ECB liquid crystal cell 110 comprises an upper substrate 107, a lower substrate 103 and a liquid layer 105 interposed therebetween. The liquid crystal layer 105 is aligned along rubbing direction R. The upper substrate 107 such as a color filter substrate comprises patterned common electrodes 106 thereon. The lower substrate 103 such as active matrix substrate comprises patterned pixel electrodes 104 thereon. The patterned common electrodes 106 and the patterned pixel electrodes 104 are staggered. The patterned common electrodes 106 and patterned pixel electrodes 104 create a symmetrical electric field such that liquid crystal molecules are affected indicating two domains. Since the two domains are symmetrical, the ECB liquid crystal cell 110 comprises the same phase differences from different observation angles (V₁ and V₂), thereby ameliorating chromatic deviation and gray scale inversion.

Although embodiments of the invention is described using patterned electrodes to realize dual domain ECB-LCD device, one of skill in the art will appreciate the suitability of other methods for creating symmetrical domains such as using an alignment layer with different aligning properties to achieve two symmetric regions. Indication of the liquid crystal molecules are redistributed and aligned towards two domains, thus equally suitable to achieve the desired results.

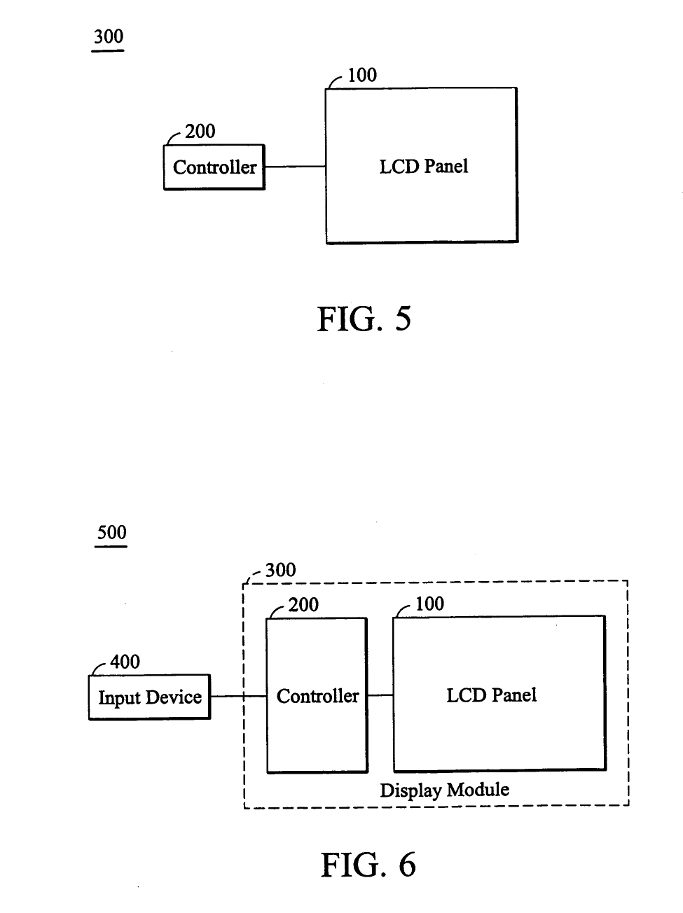

FIG. 5 is a schematic diagram of a display module 300 comprising a dual domain ECB-LCD panel 100 of the invention. The dual domain ECB-LCD panel 100 can be coupled to a controller 200, forming a display module 300. As shown in FIG. 5, the controller 200 can comprise source and gate driving circuits (not shown) to control the dual domain ECB-LCD panel 100 to render image in accordance with an input data.

FIG. 6 is a schematic diagram of an electronic device 500, incorporating a display module 300 comprising the dual domain ECB-LCD panel 100 of the invention. An input device 400 is coupled to the controller 200 of the display module 300. In FIG. 6, the input device 400 can include a processor or the like to input data to the controller 200 to render an image. The electronic device 500 may be a portable device such as a PDA, notebook computer, tablet computer, cellular phone, a desktop computer, television, car display, global positioning system (GPS), avionics display or portable DVD player.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for displaying images comprising a dual domain electrically controlled birefringence liquid crystal display (ECB-LCD) panel having two domains, each domain comprising different liquid crystal orientations.

2. The system for displaying images as claimed in claim 1, further comprising:
a pair of uniaxial ¼λ compensation films separately disposed on both sides of the ECB-LCD panel;
a pair of uniaxial ½λ compensation films separately disposed on each of the pair of uniaxial ¼λ compensation films; and
a pair of polarizers separately disposed on each of the pair of uniaxial ½λ compensation films.

3. The system for displaying images as claimed in claim 1, wherein the two domains are symmetrical structures.

4. The system for displaying images as claimed in claim 1, wherein the dual domain electrically controlled birefringence liquid crystal display (ECB-LCD) panel comprises:
a first substrate with a patterned first electrode thereon;
a second substrate opposing the first substrate with a gap interposed therebetween, wherein a patterned second electrode is disposed on the second substrate; and
a liquid crystal layer interposed in the gap between the first and the second substrates.

5. The system for displaying images as claimed in claim 4, wherein the patterned first electrode and the patterned second electrode are staggered.

6. The system for displaying images as claimed in claim 1, further comprising a substrate and an alignment layer disposed thereon, wherein the alignment layer comprises two symmetric regions, each of which provides liquid crystal molecules different orientations.

7. The system for displaying images as claimed in claim 1, further comprising a controller coupled to the dual domain ECB-LCD panel to control the panel to render an image in accordance with an input.

8. The system for displaying images as claimed in claim 7, further comprising an input device coupled to the controller to control the dual domain ECB-LCD panel to render an image.

9. A system for displaying images comprising:
a dual domain electrically controlled birefringence liquid crystal display (ECB-LCD) panel comprising:
a first substrate with a patterned first electrode thereon;
a second substrate opposing the first substrate with a gap interposed therebetween, wherein a patterned second electrode is disposed on the second substrate; and
a liquid crystal layer interposed in the gap between the first and the second substrates.

10. The system for displaying images as claimed in claim 9, further comprising:
a first uniaxial ¼λ compensation film disposed on an outer surface of the first substrate;
a second uniaxial ¼λ compensation film disposed on an outer surface of the second substrate;
a first uniaxial ½λ compensation film disposed on an outer surface of the first uniaxial ¼λ compensation film;
a second uniaxial ½λ compensation film disposed on an outer surface of the second uniaxial ¼λ compensation film;
a first polarizer disposed on an outer surface of the first uniaxial ½λ compensation film; and
a second polarizer disposed on an outer surface of the second uniaxial ½λ compensation film.

11. The system for displaying images as claimed in claim 9, wherein the dual domain ECB-LCD panel comprises two domains, each domain comprising different liquid crystal orientations.

12. The system for displaying images as claimed in claim 11, wherein the two domains are symmetrical structures.

13. The system for displaying images as claimed in claim 9, wherein the patterned first electrode and the patterned second electrode are staggered.

14. The system for displaying images as claimed in claim 9, further comprising a controller coupled to the dual domain ECB-LCD panel to control the panel to render an image in accordance with an input.

15. The system for displaying images as claimed in claim 14, further comprising an input device coupled to the controller to control the dual domain ECB-LCD panel to render an image.
